(19) United States
(12) Patent Application Publication
(10) Pub. No.: US 2008/0251591 A1
(43) Pub. Date: Oct. 16, 2008

(54) THERMOELEMENT AND THERMOSTAT APPARATUS USING THE THERMOELEMENT

(75) Inventors: Kenji MIYAMOTO, Tokyo (JP); Kenji KIMISHIMA, Tokyo (JP); Shinya ATSUMI, Hamamatsu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: NIPPON THERMOSTAT CO., LTD., Tokyo (JP); YAMAHA MARINE KABUSHIKI KAISHA, Hamamotsu-shi (JP)

(21) Appl. No.: 11/872,310

(22) Filed: Oct. 15, 2007

(30) Foreign Application Priority Data
Oct. 16, 2006 (JP) 2006-281228

(51) Int. Cl. F16K 31/68

(52) U.S. Cl. 236/99 K

(57) ABSTRACT

According to the present invention, there is provided a thermoelement that suppresses the corrosion or corrosion products occurring on an outer peripheral surface of a piston and an inner wall of a guide portion so that the piston reciprocates surely and smoothly, and a thermostat apparatus using this thermoelement. The thermoelement according to the present invention includes a wax case that internally has a wax, which is an expanding body, a piston to which responsive action of the expansion and contraction of the wax is transmitted, and a guide portion that guides the sliding of the piston, wherein the guide portion is made of brass containing 69 mass % or more and 80 mass % or less of copper component, 2 mass % or more and 4 mass % or less of silicon component, 0.1 mass % or less of lead component, and the balance of zinc, and the piston is made of stainless steel.

### BACKGROUND OF THE INVENTION

1. Field of the Invention

The present invention relates to a thermoelement that is arranged in an internal combustion engine, and shuts off and communicates a cooling liquid flow passage to thereby control the flow of a cooling liquid, and a thermostat apparatus using this thermoelement.

2. Description of the Related Art

As a cooling system of an internal combustion engine, a thermostat apparatus using a thermoelement is now used widely, as shown in Patent Document 1 (Japanese Patent Application Laid-Open No. 2002-39433), for example.

This thermoelement is described with reference to FIGS. 7 and 8. A thermoelement 100 includes a wax case 102 that internally has a wax 101, which is an expanding body, and a diaphragm 104 that transmits the expansion and contraction of the wax 101 to a semifluid 103, which is an upper layer.

Moreover, the thermoelement 100 includes a rubber piston 105 to which responsive action of the diaphragm 104 is transmitted through the semifluid 103, and a backup plate 106 to which the responsive action of the rubber piston 105 is transmitted.

Furthermore, the thermoelement 100 includes a piston 107 to which the responsive action of the backup plate 106 is transmitted and that presses a valve element not shown, and a housing part 108 that houses these components therein so as to form a layered structure.

A portion of the housing part 108 that houses the piston 107 is a guide portion 108a that guides the piston 107, and an outer peripheral surface of the piston 107 slides on an inner wall surface of the guide portion 108a, by which the piston 107 reciprocates.

When the thermoelement 100 constituted in this manner is arranged in a cooling liquid not shown, the temperature of the cooling water is transmitted to the wax 101 inside the wax case 102 through the housing part 108 and the wax case 102.

As the temperature of the cooling water rises over time, the wax 101 inside the wax case 102 expands from a state shown in FIG. 8A and increases in volume. With this increase in volume, the diaphragm 104 bulges upward. This upward bulge of the diaphragm 104 pushes the rubber piston 105, the backup plate 106, and the piston 107 upward through the semifluid 103, resulting in a state shown in FIG. 8B.

At this time, the piston 107 slides with the outer peripheral surface thereof guided by the inner wall surface of the guide portion 108a, so that the piston 107 moves and opens the valve element not shown.

On the other hand, as the temperature of the cooling water lowers over time, the wax 101 inside the wax case 102 contracts from the state shown in FIG. 8B and decreases in volume. Since repulsive force of a spring not shown acts on the piston 107, the piston 107 is pushed downward and returns to the initial state (FIG. 5A).

At this time, the piston 107 slides with the outer peripheral surface thereof guided by the inner wall surface of the guide portion 108a, so that the piston 107 moves and closes the valve element not shown.

Since the thermoelement is arranged in the cooling water, the cooling water enters between the outer peripheral surface of the piston and the inner wall of the guide portion.

Thus, there has been a technical problem in that corrosion or/and corrosion products occur on the outer peripheral surface of the piston and the inner wall of the guide portion, which hinders the smooth sliding of the piston. Particularly, in the case of a marine thermoelement (for ship), seawater is used as the cooling water, which has posed a technical problem in that corrosion or corrosion products occur more easily than a normal case where fresh water is used as the cooling water.

### SUMMARY OF THE INVENTION

The present invention is devised in order to solve the problem, and an object of the present invention is to provide a thermoelement that suppresses corrosion and corrosion products occurring on an outer peripheral surface of a piston and an inner wall of a guide portion to allow sure and smooth reciprocation of the piston, and a thermostat apparatus using this thermoelement.

A thermoelement according to the present invention devised in order to solve the above-described problem includes a wax case that internally has a wax, which is an expanding body, a piston to which responsive action of the expansion and contraction of the wax is transmitted, and a guide portion that guides the sliding of the piston, wherein the guide portion is made of brass containing 69 mass % or more and 80 mass % or less of copper component, 2 mass % or more and 4 mass % or less of silicon component, 0.1 mass % or less of lead component, and the balance of zinc, and the piston is made of stainless steel.

In this manner, since the guide portion contains less lead component and zinc component as compared with a general brass material, it is excellent in corrosion resistance, and the occurrence of the corrosion and corrosion products is suppressed, which allows the piston to slide surely and smoothly.

Namely, since the guide portion contains less lead component and zinc component in contrast to the general brass material, it is excellent in corrosion resistance, and the occurrence of the corrosion and corrosion products is suppressed. Moreover, since the piston is made of stainless steel, it is excellent in corrosion resistance, and the occurrence of the corrosion and corrosion products is suppressed. As a result, the smooth sliding of the piston is enabled.

Moreover, it is desirable that a rubber member in contact with the outer peripheral surface of the piston be attached to a terminal end portion of the guide portion.

In this manner, in the case where the rubber member in contact with the outer peripheral surface of the piston is attached to the terminal end portion of the guide portion, it is possible to prevent the cooling water from entering a clearance between the inner wall surface of the guide portion and the outer peripheral surface of the piston.

Furthermore, according to the present invention, there is provided a thermostat apparatus which is arranged in a cooling water passage of an internal combustion engine to open and close the cooling water passage, wherein a valve that moves along with reciprocation of the piston of the thermostat element is provided, and the movement of the valve allows the cooling water passage to open or close.

In this manner, the thermoelement can be suitably used in the thermostat apparatus which is arranged in the cooling water passage of the internal combustion engine to open and close the cooling water passage.

According to the present invention, the thermoelement that suppresses corrosion and corrosion products occurring in the outer peripheral surface of the piston and the inner wall of the guide portion to allow sure and smooth reciprocation of the piston, and the thermostat apparatus using this thermoelement can be attained.

### BRIEF DESCRIPTION OF THE DRAWINGS

FIG. 1 is an exploded perspective view of a thermostat apparatus according to the present invention;

FIG. 2 is a cross-sectional view of a thermoelement according to the present invention;

FIG. 3 is a perspective view of a valve and spring holders shown in FIG. 1;

FIG. 4 is a bottom view showing a holding state of a spring by the spring holders;

FIG. 5 is a cross-sectional view showing a valve closed state of the thermostat apparatus shown in FIG. 1;

FIG. 6 is a cross-sectional view showing a valve opened state of the thermostat apparatus shown in FIG. 1;

FIG. 7 is a perspective view showing a conventional thermoelement;

FIG. 8A is a cross-sectional view of the thermoelement shown in FIG. 7, showing a state where a piston is retracted; and

FIG. 8B is a cross-sectional view of the thermoelement shown in FIG. 7, showing a state where the piston is projected.

### DESCRIPTION OF THE PREFERRED EMBODIMENTS

One embodiment of a thermoelement according to the present invention and a thermostat apparatus using this thermoelement is described below.

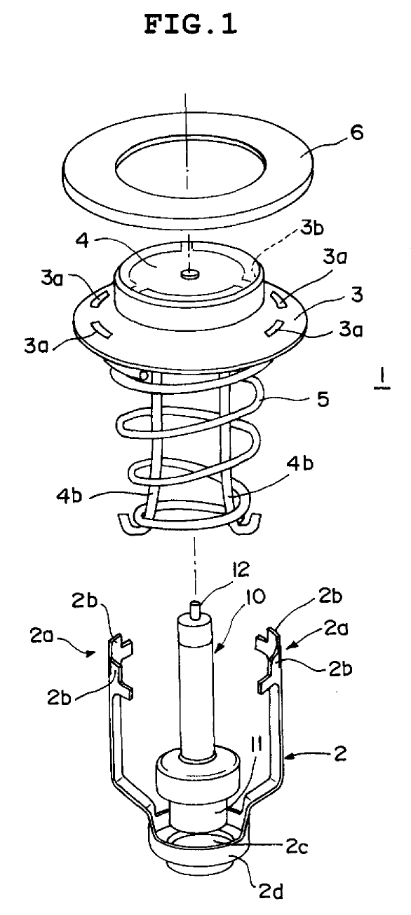

Referring to FIG. 1, the thermostat apparatus is first described. As shown in FIG. 1, a thermostat apparatus 1 includes a frame 2 that holds a wax case 11 of a thermoelement 10, and a valve sheet 3 to which upper ends of the frame 2 are fixed.

In upper ends 2a of this frame 2 are formed projected portions 2b, which are inserted into and fixed to through-holes 3a formed in an outer peripheral portion of the valve sheet 3, respectively. Also, in a lower end 2c of the frame 2 is formed an annular portion 2d that holds the wax case 11.

Moreover, in a central portion of the valve sheet 3, a cylindrical opening portion 3b is provided, and a valve 4 that opens and closes the opening portion 3b seats on an upper end surface of this opening portion 3b.

In a lower surface of this valve 4 are formed a stat 4a that receives a terminal end portion of a piston 12 of the thermoelement 10, and spring holders 4b that hold a spring 5 located around the stat 4a and are extended downward from the lower surface of the valve.

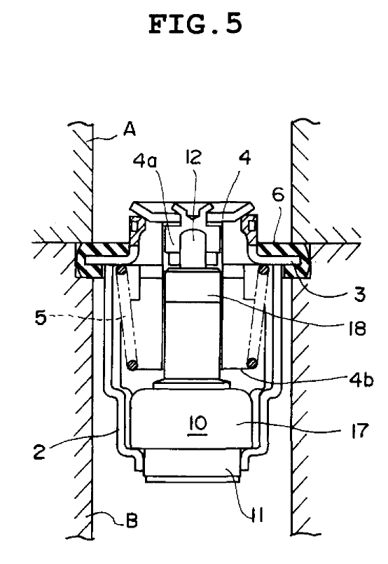

In the stat 4a, a depressed portion is formed, whose cross-sectional shape is shown in FIG. 5, and the terminal end of the piston 12 is loosely fitted into this depressed portion.

Moreover, the spring 5 is provided in such a manner that one end thereof is held by the spring holders 4b, and the other end thereof abuts against the lower surface of the valve sheet 3. A winding end surface 5a, which is a winding start of the spring 5, is located and held on the spring holder 4b, as shown in FIG. 4.

Since the winding end surface 5a of the spring 5 is located and held on the spring holder 4b in this manner, the spring 5 is held stably. Therefore, when the spring 5 receives compressive force, the spring 5 is compressed uniformly without tilting. As a result, the valve 4 can be opened and closed without tilting with respect to the opening portion 3b.

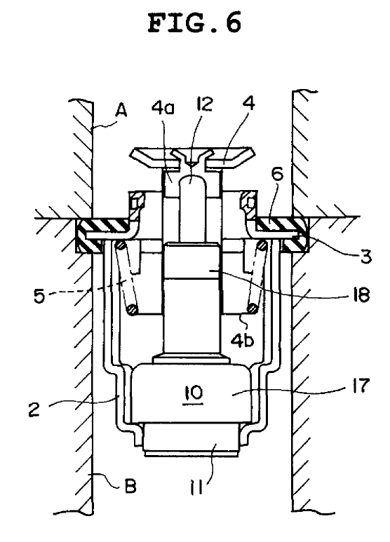

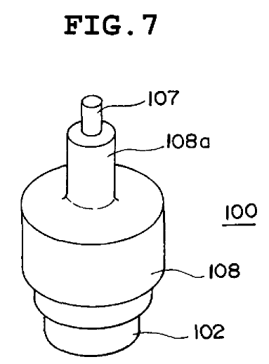

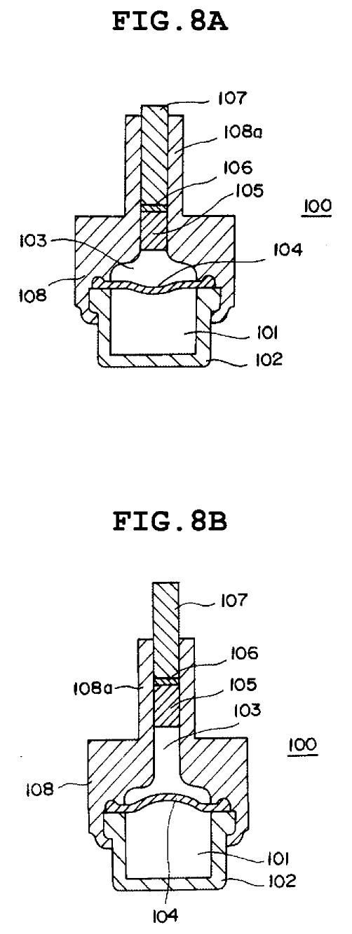

An outer peripheral portion of the valve sheet 3 is covered with a ring rubber element 6. This ring rubber element 6 is sandwiched closely between cooling-passage side walls A, B, as shown in FIGS. 5 and 6.

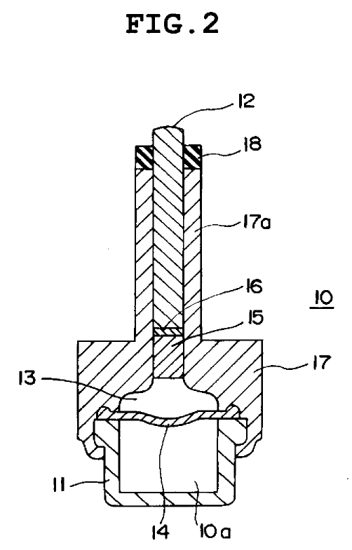

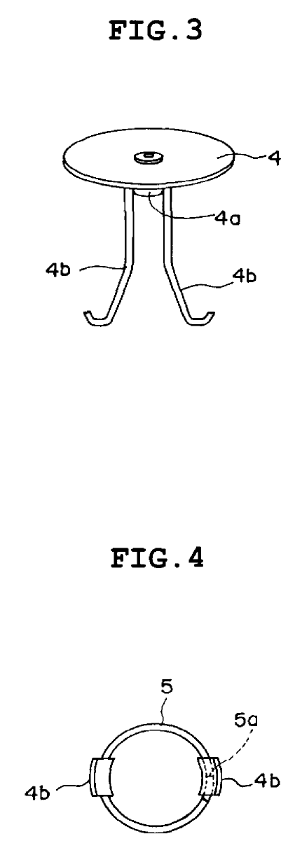

Next, one embodiment of the thermoelement 10 according to the present invention is described with reference to FIG. 2.

This thermoelement basically has a similar constitution to that of a conventional thermoelement.

Namely, the thermoelement 10 includes the wax case 11 that internally has a wax 10a, which is an expanding body, and a diaphragm 14 that transmits expansion and contraction of the wax 10a to a semifluid 13, which is an upper layer.

Moreover, the thermoelement 10 includes a rubber piston 15 to which responsive action of the diaphragm 14 is transmitted through the semifluid 13, and a backup plate 16 to which the responsive action of the rubber piston 15 is transmitted.

Furthermore, the thermoelement 10 includes the piston 12 to which the responsive action of the backup plate 16 is transmitted and that presses a valve element not shown, and a housing part 17 that houses these components therein so as to form a layered structure.

A portion of the housing part 17 that houses the piston 12 is a guide portion 17a that guides the piston 12, and an outer peripheral surface of the piston 12 slides on an inner wall surface of the guide portion 17a so that the piston 12 reciprocates.

Particularly, a feature of the thermoelement 10 according to the present invention is materials of the guide portion 17a and the piston 12. Namely, the thermoelement 10 is characterized in that the guide portion 17a is made of brass containing 69 to 80 mass % of copper component, 2 to 4 mass % of silicon component, and 0.1 mass % of lead, and the balance of zinc, and that the piston is made of stainless steel.

Here, this material of the guide portion 17a is characterized in containing less lead component (Pb) and zinc component (Zn), and more copper component (Cu), and further having silicon component (Si) added, as compared with a general brass material.

Namely, a general brass material, for example, contains 60.1 mass % of copper component (Cu), 3.1 mass % of lead component (Pb), 0.1 mass % of iron (Fe), 0.3 mass % of tin component (Sn), and the balance of zinc component (Zn). In this manner, while the general brass material contains about 3 mass % of lead component (Pb), in the brass material making up this guide portion 17a, the lead component (Pb) is reduced as much as possible to 0.1 mass % or less. As its alternative, silicon component (Si) is contained.

Moreover, while the general brass material contains about 60 mass % of copper component (Cu), the brass material making up this guide portion 17a contains 69 to 80 mass % of copper component (Cu), and less zinc component (Zn). The above-described reduction in lead component (Pb) and zinc component (Zn) as much as possible increases corrosion resistance and suppresses the occurrence of corrosion or corrosion products.

Also, the piston 12, being made of stainless steel, is excellent in corrosion resistance.

As this stainless steel material, for example, SUS304 material is used.

When the piston 12 is formed, preservative treatment is applied. This preservative treatment is conducted by immersing the piston material made of stainless steel in nitric acid liquid. Namely, the piston material is immersed in the nitric acid liquid to melt an iron layer on a piston surface, and combine chrome and oxygen more. This strengthens an oxide layer on the surface of the piston material. Since the piston 12 is made of the stainless steel material in this manner, the occurrence of the corrosion or corrosion products can be suppressed. Furthermore, in the case where the preservative treatment is applied, the corrosion and corrosion products are further suppressed.

A rubber member 18 in contact with an outer peripheral surface of the piston 12 is attached to a terminal end portion of the guide portion 17a. Since the rubber member 18 in contact with the outer peripheral surface of the piston 12 is attached to the terminal end portion of the guide portion 17a, cooling water can be prevented from entering a clearance between the inner wall surface of the guide portion 17a and the outer peripheral surface of the piston 12.

Thus, when the thermostat apparatus 1 constituted in this manner is arranged in the cooling liquid as shown in FIG. 5, the temperature of the cooling water is transmitted to the wax 10a inside the wax case 11 through the housing part 17 and the wax case 11.

As the temperature of the cooling water rises over time, the wax 10a inside the wax case 11 expands and increases in volume, and with this increase in volume, the diaphragm 14 bulges upward. This upward bulge of the diaphragm 14 pushes the rubber piston 15, the backup plate 16, and the piston 12 upward through the semifluid 13. At this time, the piston 12 slides with the outer peripheral surface thereof guided by the inner wall surface of the guide portion 17a, so that the piston 12 moves up and opens the valve 14 as shown in FIG. 6.

On the other hand, as the temperature of the cooling water lowers over time, the wax 10a inside the wax case 11 contracts and decreases in volume. Since repulsive force of the spring 5 acts on the piston 12, the piston 12 is pushed downward and returns to the initial state. At this time, the piston 12 slides with the outer peripheral surface thereof guided by the inner wall surface of the guide portion 17a, so that the piston 12 moves down and closes the valve as shown in FIG. 5.

When the thermostat apparatus 1 performs the opening and closing operation of the valve 4, the outer peripheral surface of the piston 12 slides on the inner wall surface of the guide portion 17a.

At this time, the rubber member 18 can suppress the cooling water entering the clearance between the inner wall surface of the guide portion 17a and the outer peripheral surface of the piston 12. Moreover, even if the cooling water enters from the clearance, since the piston 12 and the guide portion 17a are made of the above-described specific materials, the occurrence of corrosion and corrosion products can be suppressed, which enables the smooth operation.

### Experimental Example 1

An experiment for verification was conducted as to whether or not the thermostat apparatus according to the present invention brings about the predetermined effect. More specifically, the guide portion of a thermostat was made of each material of Examples 1 to 4 and Comparative Examples 1 to 6 shown in Table 1, and the piston was formed of stainless steel to manufacture a thermostat apparatus. This manufactured thermostat apparatus was misted with salt water and the occurrence of the corrosion and corrosion products, and the operation state of the thermostat were verified. The salt water misting was conducted for 1000 hours at an environmental temperature of 35° C. with a misted salt water concentration of 30%.

As a result, in Examples 1 to 4, no occurrence of corrosion and corrosion products was observed, and the thermostat apparatus operated smoothly. In contrast, in Comparative Examples 1 to 6, the occurrence of corrosion and corrosion products was observed, and the thermostat apparatus operated, but not smoothly.

TABLE 1
(Mass %)

| | Cu | Pb | Si | Fe | Sn | P | Zn | Others |
|---|---|---|---|---|---|---|---|---|
| Example 1 | 69 | 0.1 | 4 | — | — | — | 26.9 | — |
| 2 | 69 | 0.1 | 2 | — | — | — | 28.9 | — |
| 3 | 80 | 0.1 | 4 | — | — | — | 15.9 | — |
| 4 | 80 | 0.1 | 2 | — | — | — | 17.9 | — |
| Comparative | 60.1 | 3.1 | 0 | 0.1 | 0.3 | — | 36.4 | — |
| Example 1 | | | | | | | | |
| 2 | 61.5 | 2.6 | 0 | — | 0.5 | 0.05 | 35.35 | — |
| 3 | 60.5 | 0.3 | 0 | 0.1 | 0.7 | — | 38.4 | — |
| 4 | 59.0 | 0.1 | 0 | 0.2 | 0.7 | — | 37.4 | 2.6 |
| 5 | 85 | 0.1 | 4 | — | — | — | 10.9 | — |
| 6 | 65 | 0.1 | 4 | — | — | — | 30.9 | — |

What is claimed is:

1. A thermostat element comprising: a wax case that internally has a wax, which is an expanding body; a piston to which responsive action of the expansion and contraction of said wax is transmitted; and a guide portion that guides the sliding of said piston,
wherein said guide portion is made of brass containing 69 mass % or more and 80 mass % or less of copper component, 2 mass % or more and 4 mass % or less of silicon component, 0.1 mass % or less of lead component, and the balance of zinc, and said piston is made of stainless steel.

2. The thermostat element according to claim 1, wherein a rubber member in contact with an outer peripheral surface of said piston is attached to a terminal end portion of said guide portion.

3. A thermostat apparatus which is arranged in a cooling water passage of an internal combustion engine to open and close the cooling water passage,
wherein a valve that moves along with reciprocation of the piston of the thermostat element according to claim 1 or claim 2 is provided, and the movement of the valve allows said cooling water passage to open and close.
